(19) United States
(12) Patent Application Publication
(10) Pub. No.: US 2009/0123154 A1
(43) Pub. Date: May 14, 2009

(54) DETECTING PRESENCE OF ROGUE ONU

(75) Inventors: RODGER DALTON, WAKE FOREST, NC (US); JASON TEETER, APEX, NC (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL LUCENT, Paris (FR)

(21) Appl. No.: 11/940,061

(22) Filed: Nov. 14, 2007

(51) Int. Cl. H04J 14/08

(52) U.S. Cl. 398/98

(57) ABSTRACT

A system, method, and computer readable medium comprising instructions for rogue Optical Network Unit (ONU) detection by analyzing the frequency content are provided. Once an optical signal is received from an optical network unit, the transition detection unit converts the optical signal to an electrical data signal. The transition detection unit then analyzes the electrical data signal to determine a presence of the rogue optical network unit. To determine presence of a rogue ONU, the transition detection unit may digitally oversample the data, filter the data with a high pass filter or measure the received signal strength.

### FIELD OF THE INVENTION

The present disclosure is generally related to Optical Network Units (ONUs), and more particularly to the detection of rogue ONUs by analyzing frequency content or time domain information of data from the optical network units.

### BACKGROUND OF THE INVENTION

The present disclosure is related to rogue ONUs on a Passive Optical Network (PON). Rogue ONUs are devices on the PON that transmit upstream when they are not supposed to. These rogue ONUs are undesirable and can be very difficult to detect and troubleshoot.

A PON is a point-to-multipoint, fiber to the premises network architecture in which unpowered optical splitters are used to enable a single optical fiber to serve multiple premises. At the source of a PON is an Optical Line Terminal (OLT), typically residing at a service provider's central office (CO). Downstream from the OLT are a number of ONUs, typically near end users. The OLT can be viewed as the source and the ONUs as the multiple destinations. These ONUs can be connected in a star arrangement using optical splitters, which reside at a premise of a user. The upstream data on the PON going from the ONUs to the OLT is time-multiplexed between the ONUs.

As previously described, rogue ONUs are devices on the PON that erroneously transmit upstream. As such, upstream light sources may interfere with one another. Therefore, what is needed is an ability to overcome the problems and limitations of detecting these rogue ONUs.

### SUMMARY OF THE INVENTION

The present disclosure provides an improved method, system, and computer readable medium comprising instructions for the detection of rogue ONUs by analyzing the frequency content or similar time domain information after an upstream optical signal is converted into the electrical domain.

The present disclosure describes a system for rogue Optical Network Unit (ONU) detection, comprises an optical network unit for sending an upstream optical signal via a non-linear medium, and a transition detection unit communicably coupled to the optical network unit for analyzing the upstream optical signal. The transition detection unit receives the optical signal from an optical network unit, converts the optical signal to an electrical data signal, and analyzing the electrical data signal to determine the presence of a rogue optical network unit. The analyzing of the electrical data signal comprises analyzing frequency content of the electrical data signal.

In one embodiment of the present disclosure, the presence of the rogue optical network unit is detected by examining data transitions of the electrical data signal and determining if data transitions of the electrical data signal are significantly closer than a nominal bit period after normal duty cycle distortion during preamble has subsided.

In another embodiment of the present disclosure, the presence of the rogue optical network unit is detected by feeding the electrical data signal through a high pass filter and into the adjustable threshold comparator and determining if transitions are occurring in the incoming data stream that are above the nominal bit rate.

In a further embodiment of the present disclosure, the presence of the rogue optical network unit is detected by digitally oversampling the electrical data signal to determine if transitions are occurring above the nominal bit rate.

In yet another embodiment of the present disclosure the presence of the rogue optical network unit is detected by determining if the optical power level of a given ONU is significantly higher than its historical power levels of the optical network unit, determining if data transitions of the electrical data signal are significantly closer than a nominal bit period after normal duty cycle distortion during preamble has subsided, and determining if an amount of jitter in the data transitions increases beyond a historical level for the optical network unit.

### BRIEF DESCRIPTION OF THE DRAWINGS

FIG. 1 depicts a first system for rogue ONU detection by analyzing the frequency domain in accordance with an embodiment of the present disclosure;

FIG. 2 depicts a flowchart of an exemplary process for detecting presence of rogue optical network unit (ONU) in accordance with one embodiment of the present disclosure;

FIG. 3 depicts a flowchart of an exemplary process for analyzing the frequency content to determine presence of rogue ONUs in accordance with one embodiment of the present disclosure;

FIG. 4 depicts a flowchart of an exemplary process for analyzing the frequency content to determine presence of rogue ONUs in accordance with a second embodiment of the present disclosure;

FIG. 5 depicts a flowchart of an exemplary process for detecting presence of rogue ONUs in accordance with a second embodiment of the present disclosure;

FIG. 6 depicts a flowchart of an exemplary process for detecting presence of rogue ONUs in accordance with a third embodiment of the present disclosure; and

FIG. 7 depicts an exemplary transition detection unit for detecting rogue ONUs.

### DETAILED DESCRIPTION OF THE INVENTION

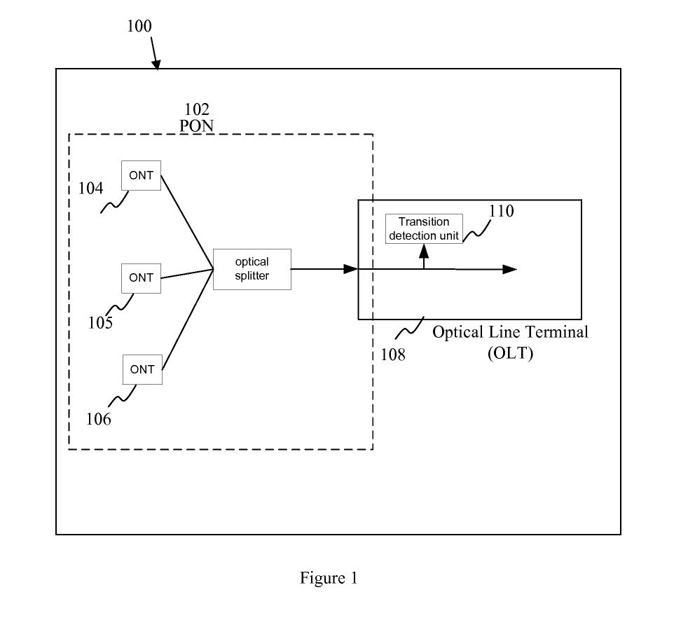

Referring now to FIG. 1, a system 100 for rogue ONU detection by analyzing the frequency content is depicted. The system 100 is an LT Optical Module comprising a number of components. The system 100 comprises a passive optical network (PON) 102. PON 102 is a point-to-multipoint fiber to premises network architecture in which unpowered optical splitters are used to enable a single LT Module to serve multiple premises.

The PON 102 comprises a plurality of optical network units or terminals (ONTs), such as ONT 104, ONT 105, and ONT 106. ONTs reside at the premise of a user and may be connected in a star arrangement using optical splitters. ONTs may be viewed as end users. In PON 102, upstream data are transmitted from the ONTs, such as ONT 104, ONT 105, and ONT 106, to an optical line terminal (OLT) 108. OLT 108 may be viewed as the source of PON 102 and typically resides at a service provider's central office (CO). Upstream data is sent from the ONTs to the OLT 108 and the upstream data is time-multiplexed between the ONTs.

As discussed above, rogue ONUs are devices on the PON 102 that erroneously transmit data upstream. These upstream data sources may interfere with one another. One aspect of the present disclosure provides a transition detection unit 110 that detects presence of such rogue ONUs by analyzing the frequency content of the upstream data sent from the ONUs after the upstream data is converted into the electrical domain. In one illustrative embodiment, the transition detection unit 110 may reside outside of the optical line terminal 108 or optical network units, for example, in a separate terminal within the passive optical network (PON) 102. In another embodiment, the transition detection unit 110 may reside within the optical line terminal 108.

Upstream data received at the transition detection unit 110 may pass through an avalanche photodiode (APD) and trans-impedance amplifier (TIA). In addition, the upstream data may also pass into a limiting amplifier (LIMA) which converts the received signal to digital signal levels. It is noted that bandwidth of receiver units, such as APD, TIA, and LIMA, is increased to allow subsequence stages to detect high-frequency signal content. While the increase of bandwidth may lead to slight loss of receive sensitivity, components with a data rate of about 2.5 Gbps may be used to implement aspects of the present disclosure.

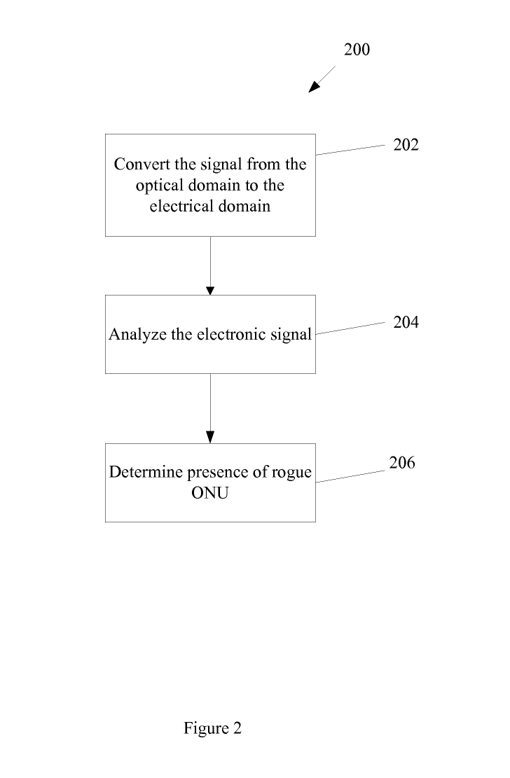

FIG. 2 provides a flowchart 200 of an exemplary process for detecting rogue optical network unit (ONU). Process 200 may be implemented as instructions executing within the transition detection unit 110. The process begins at step 202 with converting the upstream optical signal sent from the ONUs from the optical domain into the electrical domain. The process continues to step 204 to analyze the electronic data signal and to step 204 to determine presence of rogue ONUs. The analysis may be performed in several ways.

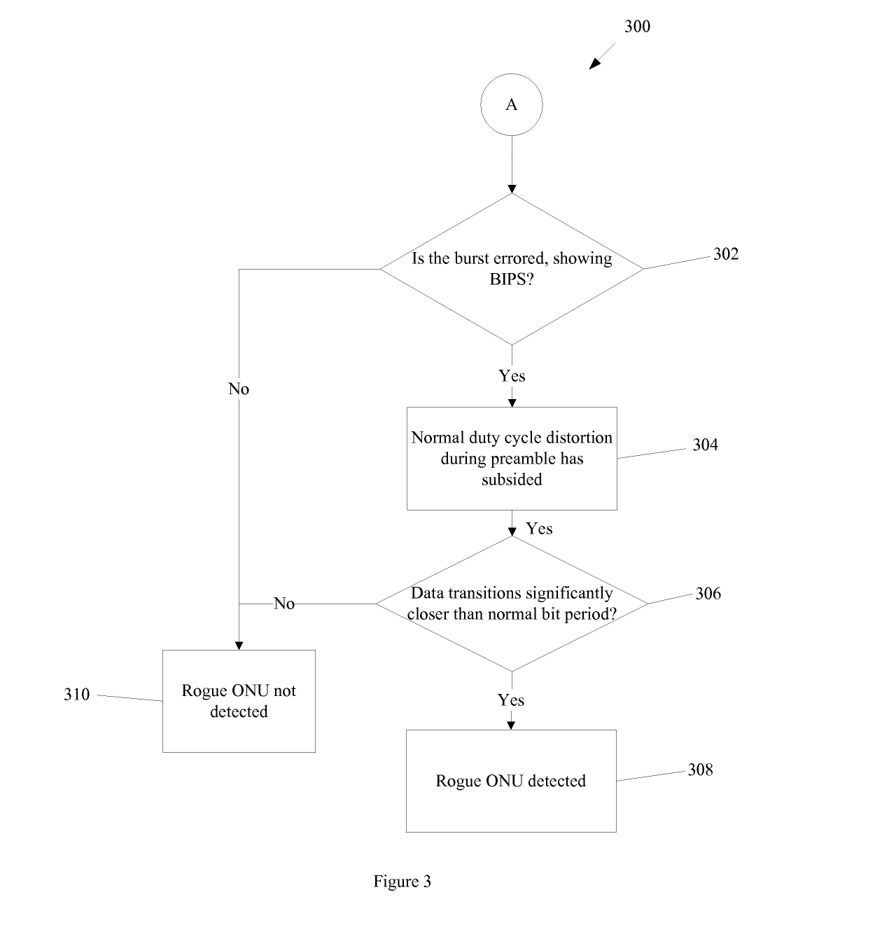

One method to analyze the electrical data signal is to analyze the frequency content of the signal. FIG. 3 provides a flowchart 300 of an exemplary process for analyzing the frequency content to determine presence of rogue ONUs in accordance with one embodiment of the present disclosure. This exemplary process may be referred to as digital oversampling. Digital oversampling involves sampling the upstream data with a clock that is substantially faster than the nominal bit rate and studying the relationship between data transitions. The process begins at step 302 with determining if a burst error, also referred to as Bit Interleaved Parity (BIP) Error is detected in PON media access controller (MAC). The PON MAC looks for the BIP error in the normal data that is provided to it at the nominal bit rate. If no burst error is detected, the process continues to step 310 to indicate that no rogue ONU is detected.

However, if a burst error is detected at step 302, the process continues to step 304 in which normal duty cycle distortion of the electrical data signal during preamble has subsided. The process then continues to step 306 to determine if edges or data transitions of the electrical data signal are significantly closer than a nominal bit period. In one example, the nominal bit period may be about 800 ps with a data rate of about 1.244 Gbps.

When a source with a different phase, such as a rogue ONU, is present, data transitions typically occur twice as often. Thus, the presence of a rogue ONU causes a strong increase in high-frequency signal content and instances where data transitions occur more frequently than the fundamental bit period of 800 ns.

If data transitions of the electrical data signal are significantly closer than the nominal bit period, the process completes at step 308 to indicate the presence of a rogue ONU. Otherwise, the process completes at step 310 to indicate that no rogue is detected.

It is noted that the above exemplary process 300 may also be applied to measure the amount of jitter in the upstream data. Since the power level of a rogue ONU may be significantly lower than the power level of the normal ONU, the rogue ONU may be unable to produce increased data transitions in the electrical data signal. Therefore, instead of data transitions occurring too closely together, the rogue ONU may cause the normal ONU's data stream to experience increased jitter above its historical norm.

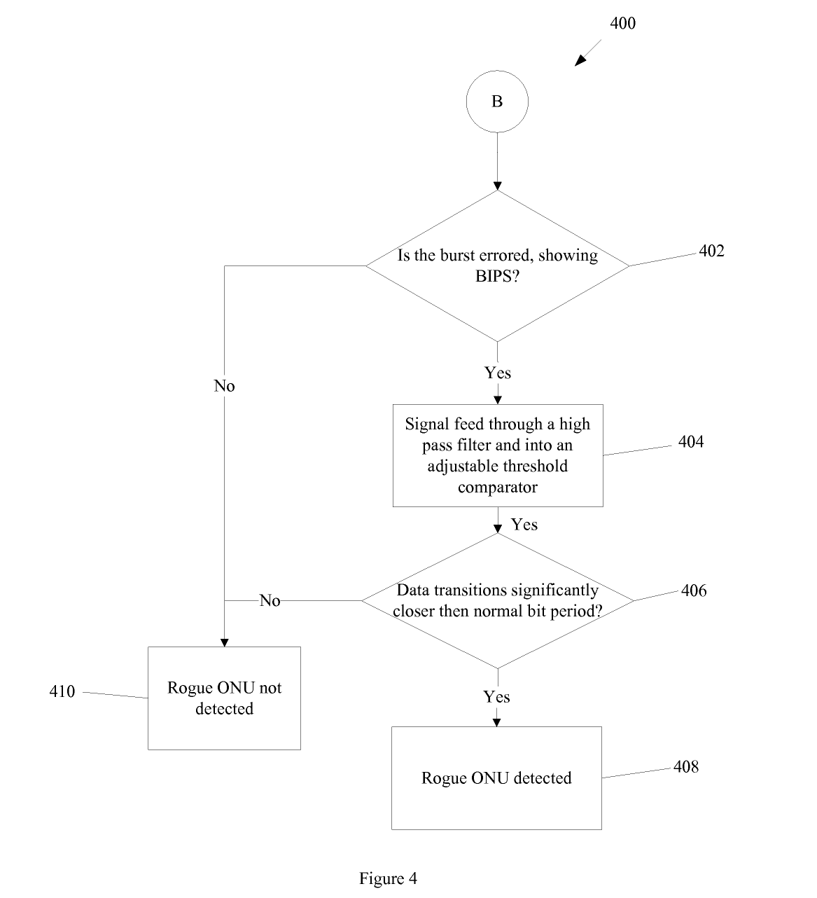

In addition to digital oversampling, another aspect of the present disclosure provides another process for analyzing the frequency content. FIG. 4 provides a flowchart 400 of a second exemplary process for detecting presence of rogue ONUs. This exemplary process may be referred to as analog filtering and detection.

The process begins at step 402 with determining if a burst error (BIP) is detected in the PON MAC. If no burst error is detected, the process continues to step 410 to indicate that no rogue ONU is detected. However, if a burst error is detected, the process continues to step 404 to feed the electrical data signal through a high pass filter. In one example, the highest frequency in the data entering the high pass filter at 1.244 Gbps is a 622 MHz square wave.

The process then continues to step 406 to feed the signal level from the high pass filter into an adjustable threshold comparator and to determine if data transitions of the incoming data signal exceed the nominal bit rate. For example, for data entering at 1.244 Gbps, frequency content above 622 MHz may indicate presence of rogue ONU because of extra data transitions caused by rogue ONU's transmission. If data transitions of the incoming signal are above the nominal bit rate, the process completes at step 408 to indicate the presence of a rogue ONU. Otherwise, the process completes at step 410 to indicate that no rogue ONU is detected.

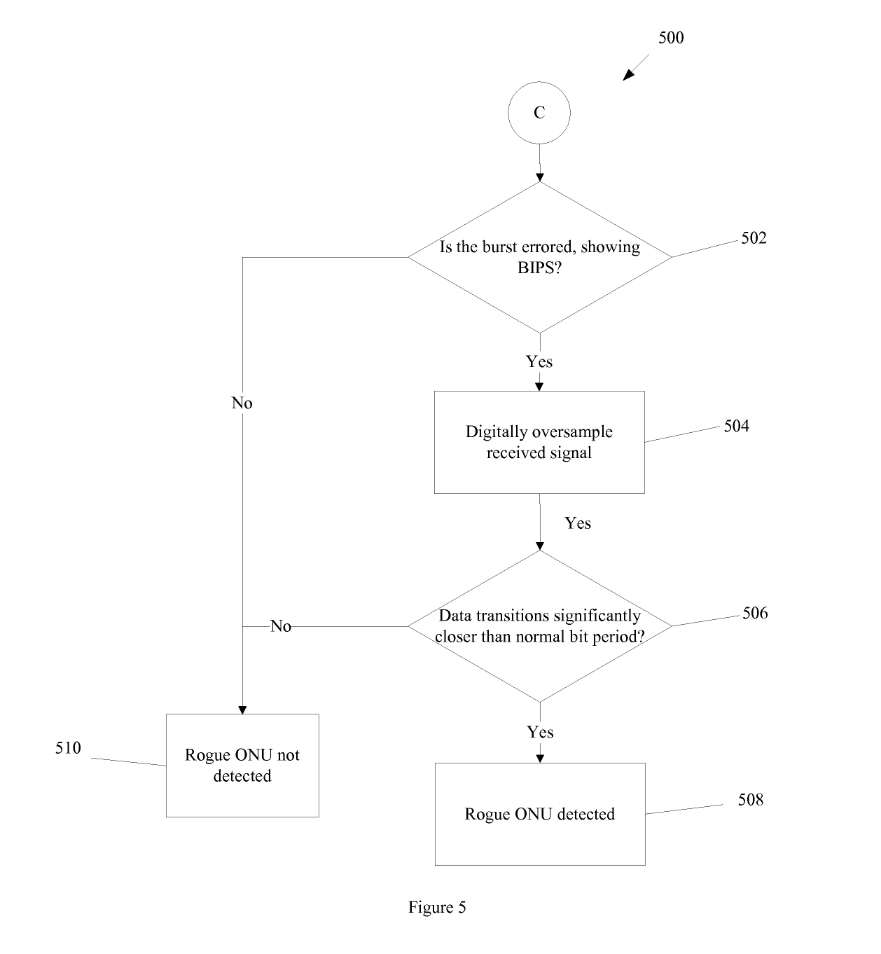

FIG. 5 provides a flowchart 500 of an exemplary process for detecting presence of rogue ONUs in accordance with a second embodiment of the present disclosure. This exemplary process may be referred to as digital signal processing.

The process begins at step 502 with determining if a burst error (BIP) is detected in the PON MAC. If no burst error is detected, the process continues to step 510 to indicate that no rogue ONU is detected. However, if a burst error is detected, the process continues to step 504 to digitally oversample the received electrical data signal.

The process continues to step 506 to determine if data transitions in the digitally oversampled signal exceed the nominal bit rate. If the data transitions exceed the nominal bit rate, the process completes at step 508 to indicate the presence of a rogue ONU. Otherwise, the process completes at step 510 to indicate that no rogue ONU is detected.

It is noted that the above exemplary process 500 is preferably performed prior to passing the data through the limiting amplifier (LIA) to allow detection of rogue ONUs at a lower power level. In addition, this exemplary process 500 is more sophisticated and more costly than other aspects of the present disclosure, because of additional technical challenges associated with monitoring weak signal levels from the TIA. Furthermore, some TIA architectures may obscure the high-frequency signal content similar to the LIA.

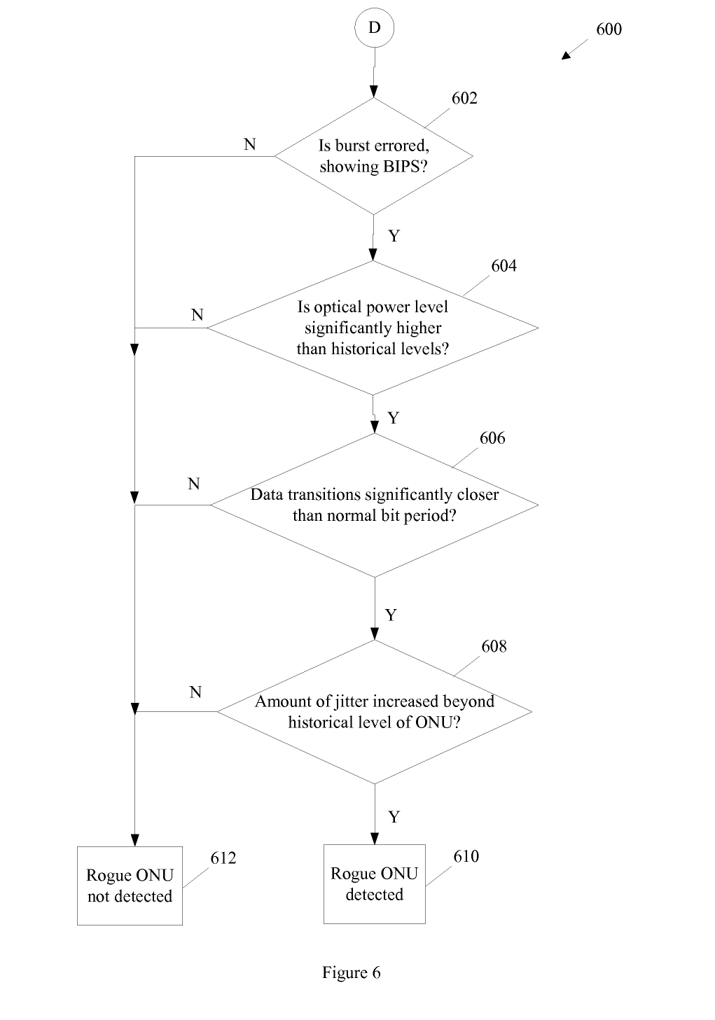

FIG. 6 provides a flowchart 600 of an exemplary process for detecting presence of rogue ONUs in accordance with a third embodiment of the present disclosure. This exemplary process combines the digital oversampling technique with received signal strength indication (RSSI).

The process begins at step 602 with determining if a burst error (BIP) is detected in the frequency content. If no burst error is detected, the process continues to step 612 to indicate that no rogue ONU is detected. However, if a burst error is detected, the process continues to step 604 to determine if the optical power level of the electrical data signal is significantly higher than historical power levels of the optical network unit. A significantly higher optical power level over historical power levels of a normal ONU strongly indicates the presence of a rogue ONU.

If the optical power lever of the electrical data signal is not significantly higher than historical power levels of the optical network unit, the process continues to step 606 to determine if data transitions of the electrical data signal are significantly closer than a nominal bit period after normal duty cycle distortion during preamble has subsided. The normal bit period may be about 800 ps with a data rate of about 1.244 Gbps. Otherwise, the process completes at step 612 to indicate that no rogue ONU is detected.

If data transitions are not significantly closer than a nominal bit period, the process continues to step 608 to determine if an amount of jitter in the data transitions increases beyond a historical level for the optical network unit. Otherwise, the process completes at step 612 to indicate that no rogue ONU is detected. The increase in the amount of jitter increases the likelihood of a rogue ONU presence.

If the amount of jitter increases beyond the historical level for the optical network unit, the process completes at step 610 to indicate the presence of a rogue ONU. Otherwise, the process completes at step 612 to indicate that no rogue ONU is detected.

It is noted that steps 604, 606, and 608 may be performed in any order or in any combination. In addition, the above exemplary process 600 is a more robust and affordable approach because it combines digital oversampling of electrical data signal with received signal strength indicator that measures optical power of the upstream data.

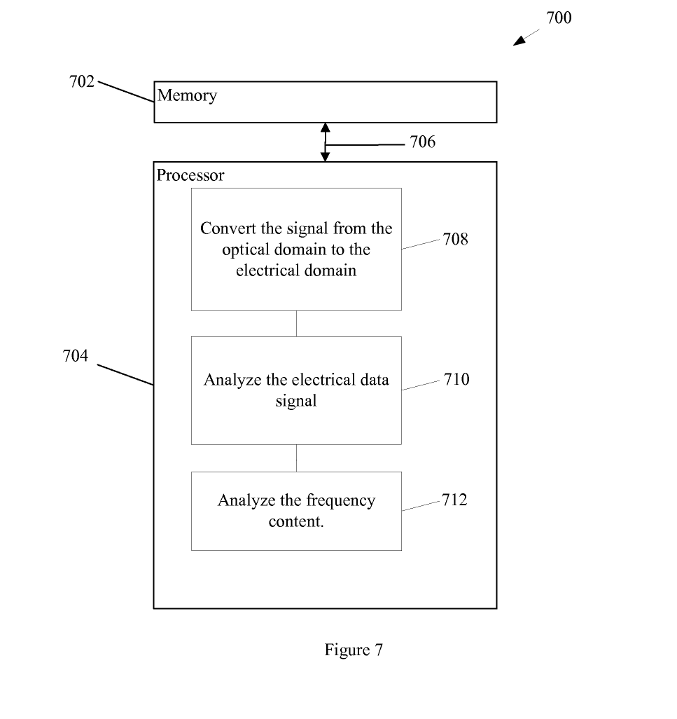

FIG. 7 provides an exemplary transition detection unit 700 for detecting rogue ONUs by analyzing the frequency content. Transition detection unit 700 may reside outside of an optical line terminal or the optical network units, for example, in a separate terminal within the passive optical network.

In this illustrative embodiment, transition detection unit 700 comprises a memory 702, and a processor 704 communicably coupled to the memory 702 via a bus 706. The processor 704 is operable to receive upstream data from ONUs, such as ONT 104 and 106 in FIG. 1. The processor 704 is also operable to convert the received optical signal from the optical domain to the electrical domain (step 708) and analyze the electrical data signal (step 710). The processor is further operable to analyze the strength of frequency content to determine the presence of a rogue ONU (step 712).

Systems and methods have been shown and/or described in the above embodiments for the detection of rogue ONUs in a PON by analyzing the frequency content. Although the above descriptions set forth preferred embodiments, it will be understood that there is no intent to limit the invention by such disclosure, but rather, it is intended to cover all modifications, substitutions and alternate implementations falling within the spirit and scope of the invention. Furthermore, the embodiments are intended to cover capabilities and concepts whether they be via a loosely coupled set of components or they be converged into one or more integrated components, devices, circuits, and/or software programs.

What is claimed is:

1. A method for detecting a rogue optical network unit (ONU), comprising:
receiving an optical signal from an optical network unit;
converting the optical signal to an electrical data signal; and
analyzing the electrical data signal to determine a presence of the rogue optical network unit.

2. The method of claim 1, wherein analyzing the electrical data signal comprises:
analyzing frequency content of the electrical data signal.

3. The method of claim 2, wherein analyzing the frequency content comprises:
determining if a burst error is detected in the frequency content; and
determining if data transitions of the electrical data signal are significantly closer than a nominal bit period after normal duty cycle distortion during preamble has subsided.

4. The method of claim 3, wherein the nominal bit period is an 800 ps bit period with a data rate of about 1.244 Gbps.

5. The method of claim 3, wherein analyzing the frequency content comprises:
feeding the electrical data signal through a high pass filter and into an adjustable threshold comparator; and
determining if data transition of the electrical data signal is above a nominal bit rate.

6. The method of claim 1, wherein analyzing the electrical data signal comprises:
digitally oversampling the electrical data signal; and
determining if data transitions in the digitally oversampled signal are above a nominal bit rate.

7. The method of claim 1, wherein analyzing the electrical data signal comprises:
determining if an optical power level of the electrical data signal is significantly higher than historical power levels of the optical network unit;
determining if data transitions of the electrical data signal are significantly closer than a nominal bit period after normal duty cycle distortion during preamble has subsided; and
determining if an amount of jitter in the data transitions increases beyond a historical level for the optical network unit.

8. A system for detecting rogue optical network unit (ONU) detection, comprising:
an optical network unit for sending an upstream optical signal via a non-linear medium;
a transition detection unit communicably coupled to the optical network unit for detecting presence of rogue optical network unit,
wherein the transition detection unit is operable to analyze the upstream optical signal and determine a presence of a rogue ONU.

9. The system of claim 8, wherein the transition detection unit is operable to convert the upstream optical signal to an electrical data signal and to analyze the electrical data signal to determine a presence of the rogue optical network unit.

10. The system of claim 9, wherein the transition detection unit is operable to analyze frequency content of the electrical data signal.

11. The system of claim 10, wherein the transition detection unit is operable to determine if a burst error is detected in the passive optical network media access control.

12. The system of claim 8, wherein the transition detection unit possesses a high bandwidth capable of receiving high frequency content.

13. The system of claim 9, wherein the transition detection unit is operable to determine if data transitions of the electrical data signal are significantly closer than a nominal bit period after normal duty cycle distortion during preamble has subsided.

14. The system of claim 13, wherein the nominal bit period is about 800 ps with a data rate of about 1.244 Gbps.

15. The system of claim 10, wherein the transition detection unit comprises a high pass filter and an adjustable threshold comparator.

16. The system of claim 15, wherein the transition detection unit is operable to feed the electrical data signal through the high pass filter and into the adjustable threshold comparator, and determine if data transitions of the electrical data signal are above a nominal bit rate.

17. The system of claim 9, wherein the transition detection unit is operable to digitally oversample the electrical data signal, and determine if data transitions in the digitally oversampled signal are above a nominal bit rate.

18. The system of claim 9, wherein the transition detection unit is operable to determine if an optical power level of the electrical data signal is significantly higher than historical power levels of the optical network unit,
determine if data transitions of the electrical data signal are significantly closer than a nominal bit period after normal duty cycle distortion during preamble has subsided, and
determine if an amount of jitter in the data transitions increases beyond a historical level for the optical network unit.

19. A computer readable medium comprising instructions for:
monitoring optical signal sending from an optical network unit;
converting the optical signal to an electrical data signal; and
analyzing the electrical data signal to determine a presence of the rogue optical network unit.

20. The computer readable medium of claim 19, further comprising instructions for analyzing frequency content of the electrical data signal to determine a presence of the rogue optical network unit.
